(19) United States
(12) Patent Application Publication
(10) Pub. No.: US 2021/0334663 A1
(43) Pub. Date: Oct. 28, 2021

(54) COMPILER-BASED METHOD FOR FAST CNN PRUNING VIA COMPOSABILITY

(71) Applicant: North Carolina State University, Raleigh, NC (US)

(72) Inventors: Xipeng Shen, Raleigh, NC (US); Hui Guan, Raleigh, NC (US)

(21) Appl. No.: 17/242,691

(22) Filed: Apr. 28, 2021

Related U.S. Application Data
(60) Provisional application No. 63/016,691, filed on Apr. 28, 2020.

(51) Int. Cl. G06N 3/08; G06K 9/62

(52) U.S. Cl. CPC G06N 3/082; G06K 9/6228

(57) ABSTRACT

The present disclosure describes various embodiments of methods and systems of training a pruned neural network. One such method comprises defining a plurality of tuning blocks within a neural network, wherein a tuning block is a sequence of consecutive convolutional neural network layers of the neural network; pruning at least one of the plurality of tuning blocks to form at least one pruned tuning block, and pre-training the at least one pruned tuning block to form at least one pre-trained tuning block. The method further comprises assembling the at least one pre-trained tuning block with other ones of the plurality of tuning blocks of the neural network to form a pruned neural network; and training the pruned neural network, wherein the at least one pre-trained tuning block is initialized with weights resulting from the pre-training of the at least one pruned tuning block. Other methods and systems are also provided.

### CROSS-REFERENCE TO RELATED APPLICATION

This application claims priority to co-pending U.S. provisional application entitled, “Compiler-Based Method for Fast CNN Pruning via Composability,” having Ser. No. 63/016,691, filed Apr. 28, 2020, which is entirely incorporated herein by reference.

### STATEMENT REGARDING FEDERALLY SPONSORED RESEARCH OR DEVELOPMENT

This invention was made with government support under grant numbers CCF1525609, CNS1717425, and CCF1703487 awarded by the National Science Foundation. The government has certain rights in the invention.

### BACKGROUND

Convolutional Neural Networks (CNN) are widely used for Deep Learning tasks. CNN pruning is an important method to adapt a large CNN model trained on general datasets to fit a more specialized task or a smaller device. The key challenge is on deciding which filters to remove in order to maximize the quality of the pruned networks while satisfying the constraints. It is time-consuming due to the enormous configuration space and the slowness of CNN training.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a convolutional neural network (CNN) diagram before CNN pruning and the network after CNN pruning in accordance with the present disclosure.

FIG. 2 shows an overview of an exemplary Wootz compiler-based framework in accordance with various embodiments of the present disclosure.

FIG. 3A shows exemplary formats for specifications of promising subspaces in accordance with various embodiments of the present disclosure.

FIG. 3B shows exemplary formats for specifications of promising objectives in accordance with various embodiments of the present disclosure.

FIG. 4 shows a concatenated sequence of layers of four networks pruned at various rates in accordance with various embodiments of the present disclosure.

FIGS. 5A-5D show an illustration of composability-based network pruning in accordance with various embodiments of the present disclosure.

FIG. 6A shows a table (Table 1) reporting size, classes, and accuracy statistics for various datasets used in training various full CNN models in accordance with the present disclosure.

FIG. 6B shows a table (Table 2) reporting the median of the initial and final accuracies of 500 block-trained networks and their default counterparts in accordance with various embodiments of the present disclosure.

FIG. 6C shows a table (Table 3) reporting comparisons between the block-trained version and the default version, in both speeds and network sizes, at various levels of tolerable accuracy drop rates in accordance with various embodiments of the present disclosure.

FIG. 6D shows a table (Table 4) reporting the speedups by composability-based pruning with different subspace sizes in accordance with various embodiments of the present disclosure.

FIG. 6E shows a table (Table 5) reporting the extra speedups brought by improved tuning block definitions in accordance with various embodiments of the present disclosure.

FIGS. 7A-7B show accuracy curves of default and block-trained networks for (A) ResNet-50 and (B) Inception-V3 CNN models.

FIGS. 8A-8B show final accuracy plots of pruned networks of ResNet-50 after training using (A) Flowers102 and (B) CUB200 datasets in accordance with various embodiments of the present disclosure.

FIG. 9 shows a schematic block diagram of a computing device that can be used to implement various embodiments of the present disclosure.

### DETAILED DESCRIPTION

The present disclosure describes various embodiments of systems, apparatuses, and methods of composability-based Convolutional Neural Networks (CNN) pruning and training.

Convolutional Neural Networks (CNN) pruning is an important method to adapt a large CNN model trained on general datasets to fit a more specialized task or a smaller device. However, CNN pruning is time-consuming due to the enormous configuration space and the slowness of CNN training. This problem has drawn many efforts from the machine learning field, which try to reduce the set of network configurations to explore.

The present disclosure tackles the problem distinctively from a programming systems perspective, trying to speed up the evaluations of the remaining configurations through computation reuse via a compiler-based framework. The present disclosure empirically uncovers the existence of composability in the training of a collection of pruned CNN models, and points out the opportunities for computation reuse. In accordance with the present disclosure, composability-based CNN pruning systems and methods are presented, and a compression-based algorithm is designed to efficiently identify the set of CNN layers to pre-train for maximizing their reuse benefits in CNN pruning. Further, a compiler-based framework named Wootz is presented, which, for an arbitrary CNN, automatically generates code that builds a Teacher-Student scheme to materialize composability-based pruning. Experiments show that network pruning enabled by Wootz shortens the state-of-art pruning process by up to 186× while producing significantly improved pruning results.

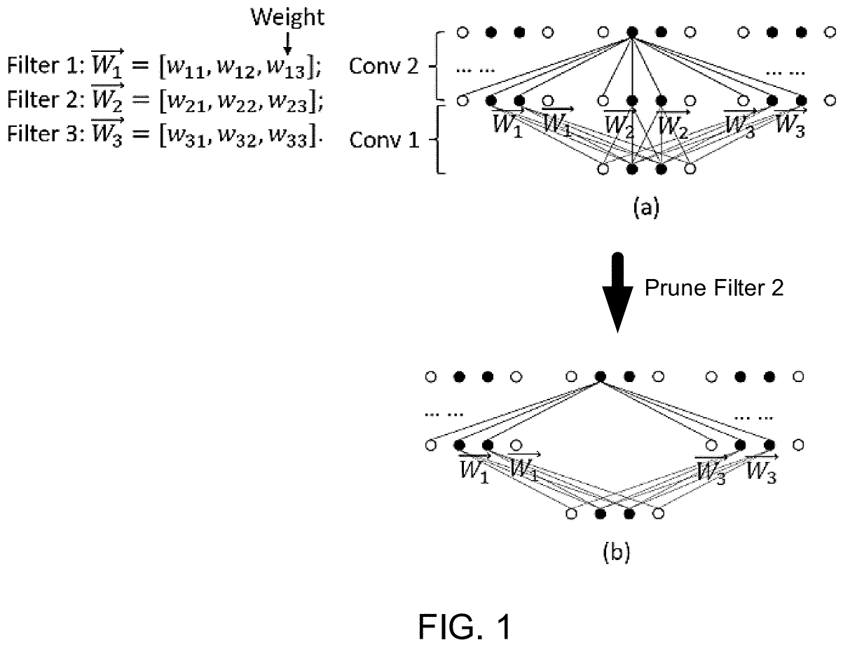

As a major class of Deep Neural Networks (DNN), Convolutional Neural Networks (CNN) are important for a broad range of deep learning tasks, from face recognition, to image classification, object detection, human pose estimation, sentence classification, and even speech recognition and time series data analysis. The core of a CNN usually contains many convolutional layers, and most computations at a layer are convolutions between its neuron values and a set of filters on that layer. A filter contains a number of weights on synapses, as FIG. 1 (as shown at the top of the figure), in which Conv1 and Conv2 are the first two consecutive convolutional layers in the CNN.

CNN pruning is a method that reduces the size and complexity of a CNN model by removing some parts, such as weights or filters, of the CNN model and then retraining the reduced model, as FIG. 1 (at the bottom of the figure) illustrates. It is an important approach to adapting large CNNs trained on general datasets to meet the needs of more specialized tasks. An example is to adapt a general image recognition network trained on a general image set (e.g., ImageNet) such that the smaller CNN (after retraining) can accurately distinguish different bird species, dog breeds, or car models. Compared to designing a CNN from scratch for each specific task, CNN pruning is an easier and more effective way to achieve a high-quality network. Moreover, CNN pruning is an important method for fitting a CNN model on a device with limited storage or computing power.

The most commonly used CNN pruning is filter-level pruning, which removes a set of unimportant filters from each convolutional layer. The key problem for filter-level pruning is how to determine the set of filters to remove from each layer to meet users' needs given that the entire configuration space can be as large as 2^{|W|} (W for the entire set of filters) and it often takes hours to evaluate just one configuration (i.e., training the pruned network and then testing it).

The problem is a major barrier for timely solution delivery in Artificial Intelligence (AI) product development. The prior efforts have been, however, mostly from the machine learning community. They leverage DNN algorithm-level knowledge to reduce the enormous configuration space to a smaller space (called promising subspace) that is likely to contain a good solution, and then evaluate these remaining configurations to find the best.

Although these prior methods help mitigate the problem, network pruning remains a time-consuming process. One reason is that, despite their effectiveness, no prior techniques can guarantee the inclusion of the desirable configuration in a much reduced subspace. As a result, to decrease the risk of missing the desirable configuration, practitioners often end up with a still quite large subspace of network configurations that takes days for many machines to explore. It is also quite often true that modifications are needed to be made to the CNN models, datasets, or hardware settings throughout the development process of an AI product, where each of the changes can make the result of a CNN pruning obsolete and call for a rerun of the entire pruning process. Conversations with AI product developers indicate that the long pruning process is one of the major hurdles for shortening the time to market AI products.

The present disclosure distinctively examines the problem from the programming systems perspective. Specifically, rather than improving the attainment of promising subspace as all prior work focuses on, the evaluations of the remaining configurations in the promising subspace are drastically sped up through cross-network computation reuse via a compiler-based framework, a direction complementary to prior solutions, via three-fold innovations of the present disclosure.

First, the present disclosure empirically uncover the existence of composability in the training of a collection of pruned CNN models, and reveal the opportunity that the composability creates for saving computations in CNN pruning. The basic observation that leads to this finding is that two CNN networks in the promising subspace often differ in only some layers. In the current CNN pruning methods, the two networks are both trained from scratch and then tested for accuracy.

In developing an exemplary composability-based CNN pruning system/method, several questions were considered, such as whether the training results of the common layers can be reused across networks to save some training time. More generally, if we view the networks in a promising subspace as compositions of a set of building blocks (a block is a sequence of CNN layers), the question is if we first pre-train (some of) these building blocks and then assemble them into the to-be-explored networks, can we shorten the evaluations of these networks and the overall pruning process? Through a set of experiments, this hypothesis was empirically validated, based on which, composability-based CNN pruning was developed for reusing pre-trained blocks for pruning.

For the next innovation, a novel hierarchical compression-based algorithm is presented that, for a given CNN and promising subspace, efficiently identifies the set of blocks to pre-train to maximize the benefits of computation reuse. The present disclosure proves that identifying the optimal set of blocks to pre-train is NP-hard. An exemplary algorithm, in accordance with the present disclosure, provides a linear-time heuristic solution by applying Sequitur, a hierarchical compression algorithm, to the CNN configurations in the promising subspace.

Finally, based on all those findings, the present disclosure presents a compiler-based framework (referred to as “Wootz”—The name is after Wootz steel, the legendary pioneering steel alloy developed in the 6th century BC. Wootz blades give the sharpest cuts.) that, for an arbitrary CNN (e.g., in Caffe Prototxt format) and other inputs, automatically generates TensorFlow code to build Teacher-Student learning structures to materialize composability-based CNN pruning, in various embodiments.

As discussed later in the present disclosure, exemplary training techniques of the present disclosure are evaluated on a set of CNNs and datasets with various target accuracies. For ResNet-50 and Inception-V3, the exemplary training techniques shorten the pruning process by up to 186.7× and 30.2× respectively. Meanwhile, the models it finds are significantly more compact (up to 70% smaller) than those used by the default pruning scheme for the same target accuracy.

As an overview of CNN pruning, for a CNN with L convolutional layers, let Wᵢ={Wᵢ^{j}} represent the set of filters on its i-th convolutional layer, and W denote the entire set of filters (i.e., W=Uᵢ₌₁^{L}Wᵢ). For a given training dataset D, a typical objective of CNN pruning is to find the smallest subset of W, denoted as W′, such that the accuracy reachable by the pruned network f (W′, D) (after being re-trained) has a tolerable loss (a predefined constant α) from the accuracy by the original network f(W,D). Besides space, the pruning may seek some other objectives, such as maximizing the inference speed, minimizing the amount of computations, or energy consumption. The optimization problem is challenging because the entire network configuration space can be as large as 2^{|W|} and it is time-consuming to evaluate a configuration, which involves the re-training of the pruned CNN. Previous work simplifies the problem as identifying and removing the least important filters. Many efficient methods on finding out the importance of a filter have been proposed in previous efforts. The pruning problem then becomes to determine how many least important filters to remove from each convolutional layer. Let γᵢ be the number of filters removed from the i-th layer in a pruned CNN and γ=(γᵢ, . . . , γ_{L}). Each γ specifies a configuration. The size of the configuration space is still combinatorial, as large as Πᵢ₌₁^{L}|Γᵢ| is the number of choices γᵢ can take.

Prior efforts have concentrated on how to reduce the configuration space to a promising subspace. But CNN training is slow and the reduced space still often takes days to explore. The present disclosure focuses on a complementary direction that accelerates the examinations of the promising configurations.

The fundamental reason for an exemplary Wootz compiler-based framework to produce large speedups for CNN pruning is its effective capitalization of computation reuse in CNN pruning, which is built on the composability in CNN pruning empirically unveiled in the present disclosure. Two pruned networks in a promising subspace often differ in only some of the layers. The basic idea of composability-based CNN pruning is to reuse the training results of the common layers across the pruned networks. Although the idea may look straightforward, to our best knowledge, no prior CNN pruning work has employed such reuse, probably due to a series of open questions and challenges.

First, there are bi-directional data dependencies among the layers of a CNN. In CNN training, for an input image, there is a forward propagation that uses a lower layer's output, which is called activation maps, to compute the activation maps of a higher layer. Forward propagation is followed by a backward propagation, which updates the weights of a lower layer based on the errors computed with the higher layer's activation maps. As a result of the bi-directional dependencies, even just one-layer differences between two networks could cause very different weights to be produced for a common (either higher or lower) layer in the two networks. Therefore, it remains unclear whether the training results of a common layer could help with the training of different networks.

Second, if a pre-trained layer could help, it is an open question how to maximize the benefits. A pre-trained sequence of consecutive layers may have a larger impact than a single pre-trained layer does on the whole network, but it may also take more time to produce and has fewer chances to be reused. How to determine which sets of layers or sequences of layers to pre-train to maximize the gains has not been explored before.

Third, the question is considered on how to pre-train just a piece of a CNN. The standard CNN back propagation training algorithm uses input labels as the ground truth to compute errors of the current network configurations and adjust the weights. If we just want to train a piece of a CNN, what ground truth should we use? What software architecture should be built to do the pre-training and do it efficiently?

Fourth, existing DNN frameworks support only the standard DNN training and inference. Users have to write code to do CNN pruning themselves, which is already complicated for general programmers. It would add even more challenges to ask them to additionally write the code to pre-train CNN pieces, and then reuse the results during the evaluations of the networks.

For the first question, a series of experiments were conducted on 16 large CNNs (four popular CNN models trained on four datasets), as discussed in detail in a later portion of the present disclosure. Here, several key observations are stated. The pre-trained layers are observed to bring a network to a much improved starting setting, making the initial accuracies of the network 50-90% higher than the network without pretrained layers. That leads to 30-100% savings of the training time of the network. Moreover, pre-training helps the network converge to a significantly higher level of accuracy (by 1%-4%). These findings empirically confirm the potential of composability-based CNN pruning.

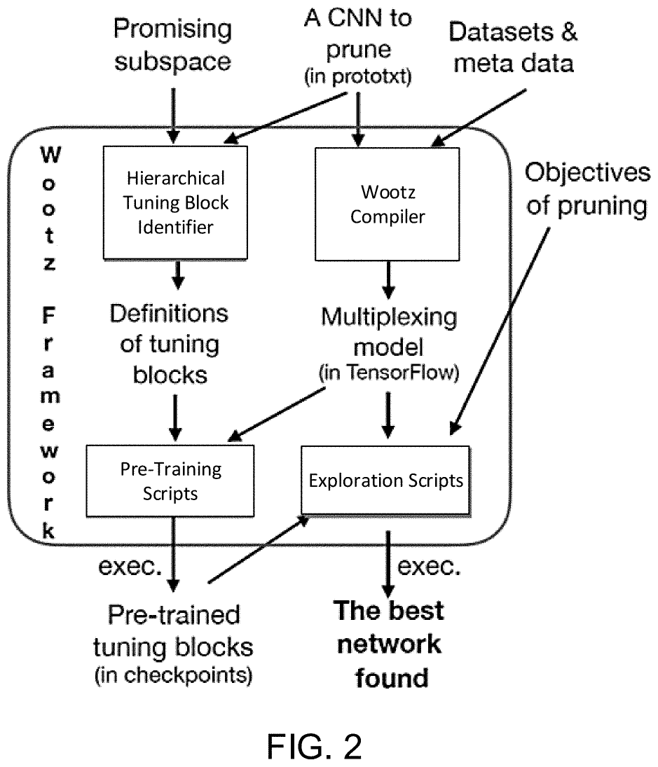

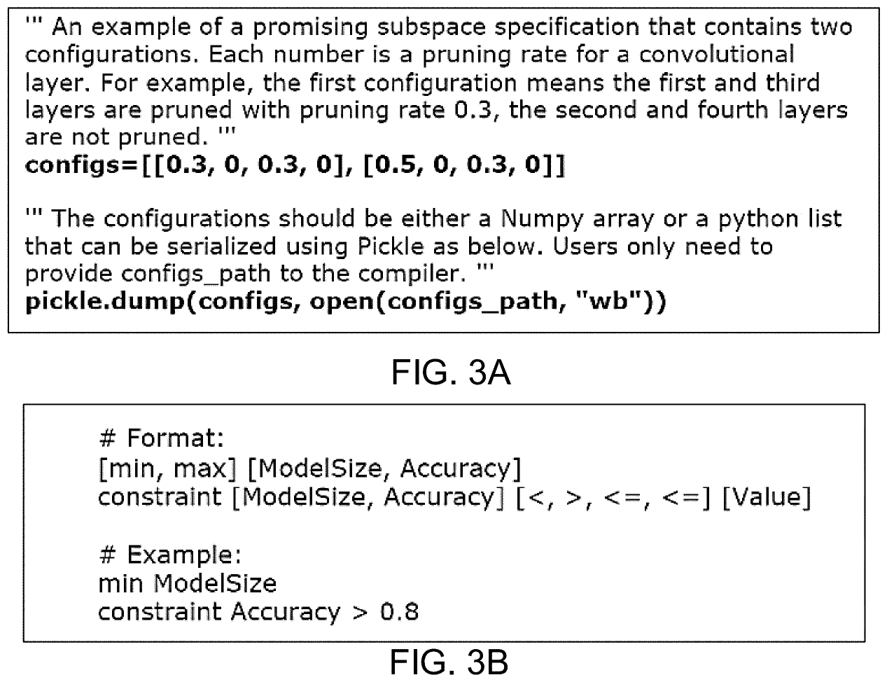

To effectively materialize the potential, the other three challenges are addressed by the Wootz compiler-based framework. In general, Wootz is a software framework that automatically enables composability-based CNN pruning. As FIG. 2 shows, in one embodiment, the input of an exemplary Wootz compiler-based framework has four parts: (A) The to-be-pruned CNN model, written in Caffe Prototxt (with a minor extension), which is a user-friendly text format (from Caffe) for CNN model specifications; (B) The promising subspace that contains the set of pruned networks configurations worth exploring, following the format in FIG. 3A. The subspace may come from the user or some third-party tools that reduce the configuration space for CNN pruning; (C) The dataset for training and testing, along with some meta data on the training (e.g., learning rates, maximum training steps), following the format used in Caffe Solver Prototxt; and (D) The objectives of the CNN pruning, including the constraints on model size or accuracy, following the format shown in FIG. 3B.

In an exemplary embodiment, the Wootz compiler-based framework includes four main components as shown in FIG. 2: (1) The hierarchical tuning block identifier tries to define the set of tuning blocks. A tuning block is a sequence of pruned consecutive CNN layers taken as a unit for pre-training. Suitable definitions of tuning blocks help maximize reuse while minimizing the pre-training overhead. (2) From the given CNN model specified in Prototxt, the Wootz compiler generates a multiplexing model, which is a function written in TensorFlow that, when invoked, specifies the structure of the full to-be-pruned CNN model, the network structure—which implements a Teacher-Student scheme—for pre-training tuning blocks, or pruned networks assembled with pre-trained tuning blocks, depending on the arguments the function receives. (3) The pre-training scripts are some generic Python functions that, when run, pre-train each tuning block based on the outputs from the first two components of Wootz. (4) The final component, exploration scripts, explores the promising pruned networks assembled with the pre-trained tuning blocks. The exploration of a network includes first fine-tuning the entire network and then testing it for accuracy. The exploration order is automatically picked by the exploration scripts based on the pruning objectives to produce the best network as early as possible. Both the pre-training scripts and the exploration scripts can run on one machine or multiple machines in a distributed environment through MPI.

The Wootz compiler framework is designed to help pruning methods that have their promising subspace known at front. There are methods that do not provide the subspace explicitly. They, however, still need to tune the pruning rate for each layer and the exploration could also contain potentially avoidable computations. Extending Wootz to harvest those opportunities is contemplated in various embodiments.

Composability-based CNN pruning faces a trade-off between the pre-training cost and the time savings the pre-training results bring. The tradeoff depends on the definitions of the unit for pre-training, that is, the definition of tuning blocks. A tuning block is a unit for pre-training, and it contains a sequence of consecutive CNN layers pruned at certain rates. The tuning block can have various sizes, depending on the number of CNN layers it contains. The smaller the tuning block is, the less pre-training time it takes and the more reuses the tuning block tends to have across networks, but at the same time, its impact to the training time of a network tends to be smaller.

So, for a given promising subspace of networks, a question for composability-based CNN pruning is how to define the best sets of tuning blocks. The solution depends on the appearing frequencies of each sequence of layers in the subspace, their pre-training times, and the impact of the pre-training results on the training of the networks. For a clear understanding of the problem and its complexity, an optimal tuning block definition problem is identified as follows.

Let A be a CNN consisting of L layers, represented as A₁⋅A₂⋅A₃⋅ . . . ⋅A_{L}, where ⋅ stands for layer stacking and Aᵢ stands for the i-th layer (counting from input layer). C={A⁽¹⁾, A⁽²⁾, . . . , A^{(N)}} is a set of N networks that are derived from filter pruning of A, where A⁽ⁿ⁾ represents the n-th derived network from A, and Aᵢ⁽ⁿ⁾ stands for the i-th layer of A⁽ⁿ⁾, i=1, 2, . . . , L.

The optimal tuning block definition problem is to come up with a set of tuning blocks B={B₁, B₂, . . . , B_{K}} such that the following two conditions are met:
1. Every Bₖ, k=1, 2, . . . , K, is part of a network in C—that is, ∀ Bₖ, ∃A⁽ⁿ⁾, n∈{1, 2, . . . , N}, such that Bₖ=Aₗ⁽ⁿ⁾⋅Aₗ₊₁⁽ⁿ⁾⋅ . . . ⋅A_{l+b}_{ₖ}₋₁⁽ⁿ⁾, 1≤l≤L−bₖ+1, where bₖ is the number of layers contained in Bₖ.
2. B is an optimal choice—that is, arg_{B}min (Σₙ₌₁^{N}T(A^{(n,B)})), where, T(Bₖ) is the time taken to pretrain block Bₖ, and T(A^{(n,B)}) is the time taken to train A^{(n,B)} to reach the accuracy objective (In our framework, T(x) is not statically known or approximated, but instead explicitly computed (via training) for each x (i.e., Bₖ or A^{(n,B)})); A^{(n,B)} is the blocked-trained version of A⁽ⁿ⁾ with B as the tuning blocks.

A restricted version of the problem is that only a predefined set of pruning rates (e.g., {30%, 50%, 70%}) are used when pruning a layer in A to produce the set of pruned networks in C—which is a common practice in filter pruning.

Even this restricted version is NP-hard, provable through a reduction of the problem to the classic knapsack problem (detailed proof omitted for sake of space). A polynomial-time solution is hence in general hard to find, if ever possible. The NP-hardness motivates the design of a heuristic algorithm, which does not aim to find the optimal solution but to come up with a suitable solution efficiently. The heuristic algorithm does not use the training time as an explicit objective to optimize but focuses on layer reuse. It is a hierarchical compression-based algorithm.

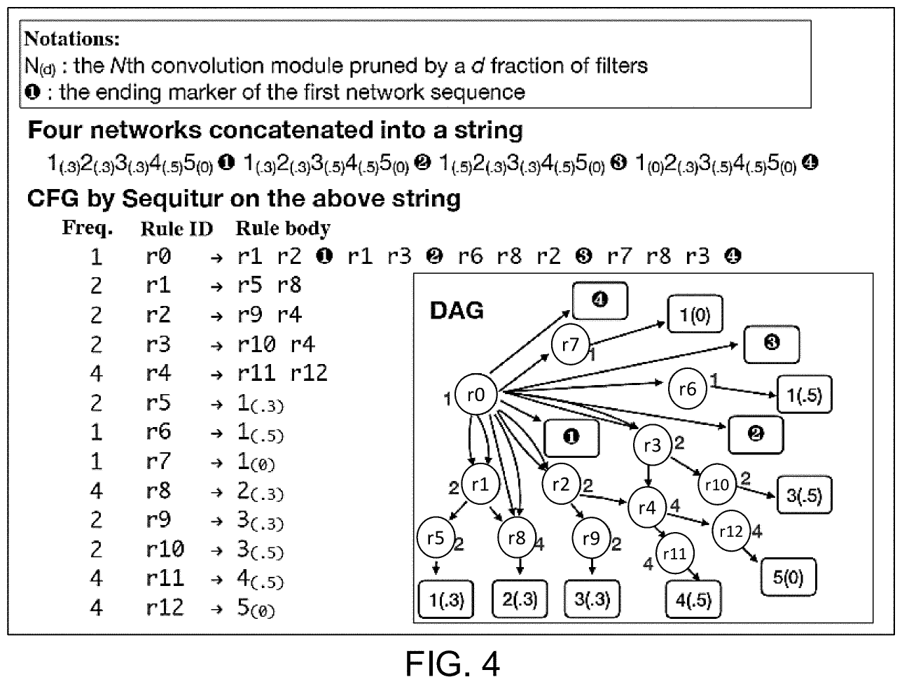

An exemplary heuristic algorithm leverages Sequitur to efficiently identify the frequent sequences of pruned layers in the network collection C. As a linear-time hierarchical compression algorithm, Sequitur infers a hierarchical structure from a sequence of discrete symbols. For a given sequence of symbols, it derives a context-free grammar (CFG), with each rule in the CFG reducing a repeatedly appearing string into a single rule ID. FIG. 4 gives an example. Its top part shows the concatenated sequence of layers of four networks pruned at various rates; the subscripts of the numbers indicate the pruning rate, that is, the fraction of the least important filters of a layer that are removed. The lower part in FIG. 4 shows the CFG produced by Sequitur on the string. A full expansion of rule r0 would give the original string. The result can also be represented as a Directed Acyclic Graph (DAG) as the right graph in FIG. 4 shows with each node corresponding to one rule.

Applying Sequitur to the concatenated sequence of all networks in the promising subspace, the exemplary hierarchical compression-based algorithm gets the corresponding CFG and the DAG. Let R be the collection of all the rules in the CFG, and S be the solution to the tuning block identification problem which is initially empty. The exemplary algorithm then heuristically fills S with subsequences of CNN layers (represented as rules in the CFG) that are worth pre-training based on the appearing frequencies of the rules in the promising subspace and their sizes (i.e., the number of layers a rule contains). The exemplary hierarchical compression-based algorithm employs two heuristics: (1) A rule cannot be put into S if it appears in only one network (i.e., its appearing frequency is one); and (2) a rule is preferred over its children rules only if that rule appears as often as its most frequently appearing descendant.

The first heuristic is to ensure that the pre-training result of the sequence can benefit more than one network. The second heuristic is based on the following observation: A pre-trained sequence typically has a larger impact than its subsequences collectively have on the quality of a network; however, the extra benefits are usually modest. For instance, a ResNet CNN network assembled from a 4-block long pre-trained sequences has an initial accuracy of 0.716 that is 3.1% higher than the same network but assembled from 1-block long pre-trained sequences. The higher initial accuracy helps have extra training steps (epochs) for the network, but the saving is limited (up to 20% of the overall training time). Moreover, a longer sequence usually has a lower chance to be reused. For these reasons, the present disclosure employs the aforementioned heuristics to help keep S small and hence the pre-training overhead low while still achieving a good number of reuses.

Specifically, an exemplary hierarchical compression-based algorithm takes a post-order (children before parent) traversal of the DAG that Sequitur produces. Before that, all edges between two nodes on the DAG are combined into one edge. At a node, the algorithm checks the node's frequency. If the frequency value is greater than one, the algorithm checks whether the node's frequency equals the largest frequency of its children. If so, the algorithm marks the node as a potential tuning block, unmarks its children, and continues the traversal. Otherwise, the algorithm puts a “dead-end” mark on the node, indicating that it is not worth going further up in the DAG from this node. When the traversal reaches the root of the DAG or has no path to continue, the algorithm puts all the potential tuning blocks into S as the solution and terminates.

Note that a side product from the process is a composite vector for each network in the promising subspace. As a tuning block is put into S, the algorithm, by referencing the CFG produced by Sequitur, records the identifier (ID) of the tuning block in the composite vectors of the networks that can use the block. Composite vectors will be used in a global fine-tuning phase (details of which are discussed in a later portion of the present disclosure).

The hierarchical compression-based algorithm is designed to be simple and efficient. More detailed modeling of the time savings and pre-training cost of each sequence for various CNNs could potentially help yield better definitions of tuning blocks, but it would add significant complexities and runtime overhead. Evaluations show that the hierarchical compression-based algorithm gives a reasonable trade-off.

The core operations in Composability-based CNN pruning includes pre-training of tuning blocks, and global fine-tuning of networks assembled with the pre-trained blocks. The standard CNN back propagation training algorithm uses input labels as the ground truth to compute errors of the current network and adjusts the weights iteratively. To train a tuning block, the first question is what ground truth to use to compute errors. Inspired by Teacher-Student networks, the present disclosure adopts a similar Teacher-Student mechanism to address the problem.

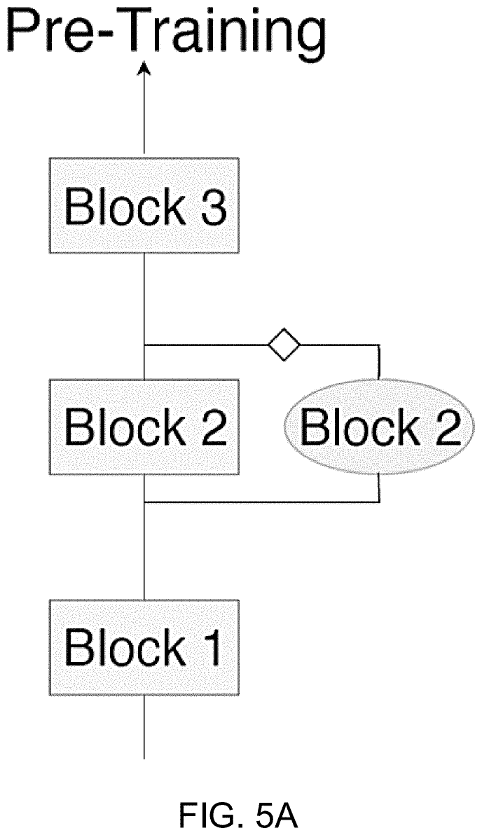

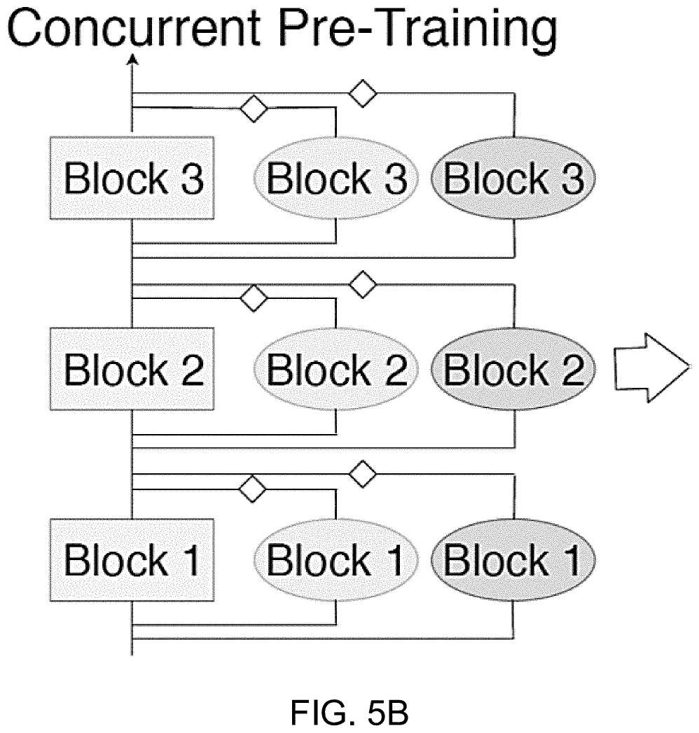

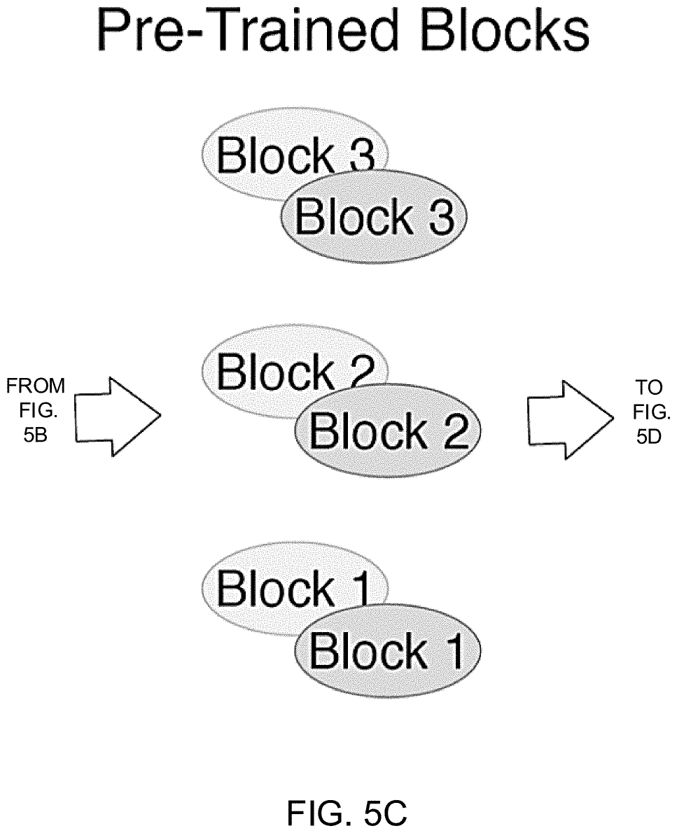

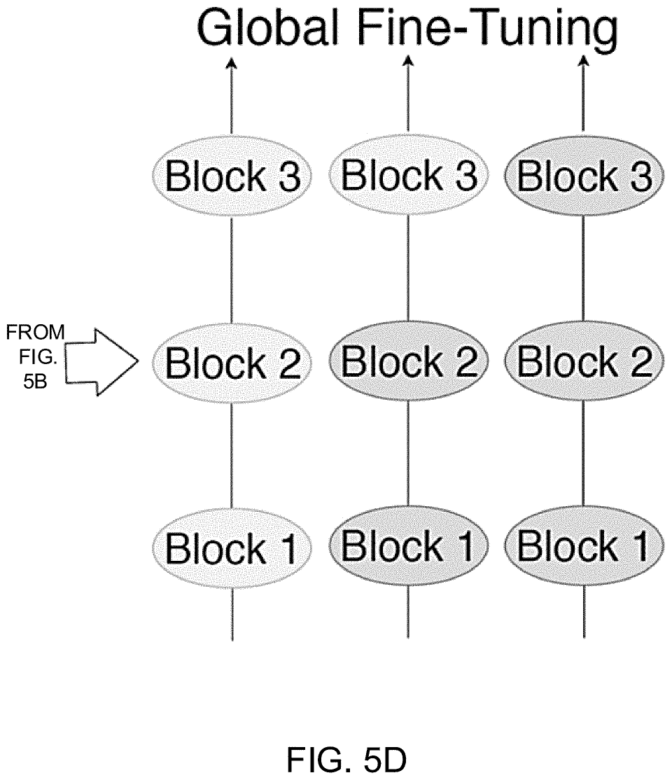

For pre-training of tuning blocks, a network structure is constructed that contains both the pruned block to pre-train and the original full CNN model. They are put side by side as shown in FIG. 5A with the input to the counterpart of the tuning block in the full model also flowing into the pruned tuning block as its input, and the output activation map of the counterpart block flowing into the pruned tuning block as the “ground truth” of its output. In the figure, eclipses are pruned tuning blocks; rectangles are original tuning blocks; diamonds refer to the activation map reconstruction error; and different colors of pruned tuning blocks correspond to different pruning options.

When the standard back propagation algorithm is applied to the tuning block in this network structure, it effectively minimizes the reconstruction error between the output activation maps from the pruned tuning block and the ones from its unpruned counterpart in the full network. In CNN pruning, the full model has typically already been trained beforehand to perform well on the datasets of interest.

This exemplary design essentially uses the full model as the “teacher” to train the pruned tuning blocks. Let Oₖ and Oₖ′ be the vectorized output activation maps from the unpruned and pruned tuning block, and Wₖ′ be the weights in the pruned tuning block. The optimization objective in this design is:

$${min}_{{W}_{k}^{′}} \frac{1}{\vert {O}_{k} \vert} {‖ {O}_{k} - {O}_{k}^{′} ‖}_{2}^{2} . \qquad ( 1 )$$

Only the parameters in the pruned tuning block are updated in this local training phase to ensure the pre-trained blocks are reusable. This Teacher-Student design has three appealing properties. First, it addresses the missing “ground truth” problem for tuning block pre-training. Second, as the full CNN model runs along with the pre-training of the tuning blocks, it provides the inputs and “ground truth” for the tuning blocks on the fly; there is no need to store the activation maps which can be space-consuming considering the large number of input images for training a CNN. Third, the structure is friendly for concurrently pre-training multiple tuning blocks. As FIG. 5B shows, connections can be added between the full model and multiple pruned blocks; the pre-training of these blocks can then happen in one run, and the activation maps produced by a block in the full model can be seamlessly reused across the pre-training of multiple pruned blocks.

The local training phase outputs a bag of pre-trained pruned tuning blocks, as shown in FIG. 5C. Tuning blocks in the original network could also be included. At the beginning of a global fine-tuning phase is an assembly step, which, logically, assembles these training blocks into each of the networks in the promising subspace. Physically, this step just needs to initialize the pruned networks in the promising subspace with the weights in the corresponding tuning blocks. The resulting network is called a block-trained network. Recall that one of the side products of the tuning block identification step is a composite vector for each network which records the tuning blocks the network can use; these vectors are used in this assembly step. FIG. 5D gives a conceptual illustration of three networks being assembled with three different sets of pre-trained tuning blocks.

As a pruned block (with only a subset of parameters) has a smaller model capacity, the global fine-tuning step is used to further recover the accuracy performance of a block-trained network. This step runs the standard CNN training on the block-trained networks. All the parameters in the networks are updated during the training. Compared with training a default pruned network, fine-tuning a block-trained network usually takes much less training time as the network starts with a much better set of parameter values.

An exemplary Wootz compiler and scripts offer an automatic way to materialize the mechanisms for an arbitrary CNN model. An exemplary implementation method is not restricted to a particular DNN framework, although its ability is demonstrated using TensorFlow.

TensorFlow offers a set of APIs for defining, training, and evaluating a CNN. To specify the structure of a CNN, one needs to call APIs in a Python script, which arranges a series of operations into a computational graph. In a TensorFlow computational graph, nodes are operations that consume and produce tensors, and edges are tensors that represent values flowing through the graph. CNN model parameters are held in TensorFlow variables, which represent tensors whose values can be changed by operations. Because a CNN model can have hundreds of variables, it is a common practice to name variables in a hierarchical way using variable scopes to avoid name clashes. A popular option to store and reuse the parameters of CNN model is TensorFlow checkpoints. Checkpoints are binary files that map variable names to tensor values. The tensor value of a variable can be restored from a checkpoint by matching the variable name.

TensorFlow APIs with other assistant libraries (e.g., Slim) offer conveniences for standard CNN model training and testing, but not for CNN pruning, let alone composability-based pruning. Asking a general programmer to implement composability-based pruning in TensorFlow for each CNN model would add tremendous burdens on the programmer. She would need to write code to identify tuning blocks, create TensorFlow code to implement the customized CNN structures to pre-train each tuning block, generate checkpoints, and use them when creating the block-trained CNN networks for global fine-tuning.

Wootz compiler and scripts mitigate the difficulty by automating the process. The fundamental motivating observation is that the codes for two different CNN models follow the same pattern. Differences are mostly on the code specifying the structure of the CNN models (both the original and the extended for pre-training and global fine tuning). The idea is to build code templates and use the compiler to automatically adapt the templates based on the specifications of the models.

In various embodiments, a key feature in an exemplary design of the Wootz compiler-based framework is to take Prototxt as the format of an input to-be-pruned CNN model. Because the Wootz tool has to derive code for pre-training and fine-tuning of the pruned models, the Wootz compiler would need to analyze the TensorFlow code from users, which could be written in various ways and be complex to analyze. Prototxt has a clean fixed format, is easy for programmers to write, and is simple for a compiler to analyze.

Given a to-be-pruned CNN model specified in Prototxt, the Wootz compiler first generates the multiplexing model, which is a piece of TensorFlow code defined as a Python function. It is multiplexing in the sense that an invocation of the code specifies the structure of the original CNN model, the structure for pre-training, or the global fine tuning model. Which of the three modes is used at an invocation of the multiplexing model is determined by one of its input arguments, mode_to_use. The multiplexing design allows easy code reuse as the three modes share common code for model specifications. Another argument, prune_info, conveys to the multiplexing model the pruning information, including the set of tuning blocks to pre-train in this invocation and their pruning rates.

The compiler-based code generation should provide mainly two-fold support. The code should map CNN model specifications in Prototxt to TensorFlow APIs. An exemplary implementation, specifically, generates calls to TensorFlow-Slim API to add various CNN layers based on the parsing results of the Prototxt specifications. The other support is to specify the derived network structure for pre-training each tuning block contained in prune_info. Note that the layers contained in a tuning block are the same as a section of the full model except for the number of filters in the layers and the connections flowing into the block. The compiler hence emits code for specifying each of the CNN layers again, but with connections flowing from the full network, and sets the “depth” argument of the layer-adding API call (a TensorFlow-Slim API) with the info retrieved from prune_info such that the layer's filters can change with prune_info at different calls of the multiplexing model. In addition, the compiler encloses the code with condition checks to determine, based on prune_info, at an invocation of the multiplexing model whether the layer should be actually added into the network for pre-training. The code generation for the global fine-tuning is similar but simpler. In such a form, the generated multiplexing model is adaptive to the needs of different modes and the various pruning settings.

Once the multiplexing model is generated, it is registered at the nets factory in Slim Model Library with its unique model name. The nets factory is part of the functional programming Slim Model Library is based on. It contains a dictionary mapping a model name to its corresponding model function for easy retrieval and use of the models in other programs.

Pre-training scripts contain a generic pre-training Python code and a wrapper that is adapted from a Python template by the Wootz Compiler to the to-be-pruned CNN model and meta data. The pre-training Python code retrieves the multiplexing model from nets factory based on the registered name, and repeatedly invokes the model function with the appropriate arguments, with each call generating one of the pre-train networks. After defining the loss function, it launches a TensorFlow session to run the pre-training process.

The wrapper calls the pre-training Python code with required arguments such as model name and the set of tuning blocks to train. As the tuning blocks coexisting in a pruned network cannot have overlapping layers, one pruned network can only enable the training of a limited set of tuning blocks. A simple algorithm is designed to partition the entire set of tuning blocks returned by the Hierarchical Tuning Block Identifier into groups. The pre-training Python script is called to train only one group at a time. The partition algorithm is as follows:

Inputs: B {the entire set of tuning blocks}
Outputs: G {the set of groups of tuning blocks}
B.sort( ) {sort by the contained lowest conv layers}
G = {{B[0]}}
for b ∈ B[1 :] do

for g ∈ G do

any([overlap(b, e) for e in g])? G.add({b}):g.add(b)

The meta data contains the training configurations such as dataset name, dataset directory, learning rate, maximum training steps, and batch size for pre-training of tuning blocks. The set of options to configure are predefined, similar to the Caffe Solver Prototxt. The compiler parses the meta data and specifies those configurations in the wrapper.

Executing the wrapper produces pre-trained tuning blocks that are stored as TensorFlow checkpoints. The mapping between the checkpoint files and trained tuning blocks are also recorded for the model variable initialization in the global fine-tuning phase. The pre-training script can run on a single node or multiple nodes in parallel to concurrently train multiple groups through MPI.

Exploration scripts contain a generic global fine-tuning Python code and a Python-based wrapper. The global fine-tuning code invokes the multiplexing model to generate the pruned network according to the configuration to evaluate. The code then initializes the network through the checkpoints produced in the pre-train process and launches a TensorFlow session to train the network.

In addition to feeding the global fine-tuning Python code with required arguments (e.g. the configuration to evaluate), the Python-based wrapper provides code to efficiently explore the promising subspace. The order of the exploration is dynamically determined by the objective function.

The compiler first parses the file that specifies the objective of pruning to get the metric that needs to be minimized or maximized. The order of explorations is determined by the corresponding MetricName. In case the MetricName is ModelSize, the best exploration order is to start from the smallest model and proceed to larger ones. If the MetricName is Accuracy, the best exploration order is the opposite order as a larger model tends to give a higher accuracy. To facilitate concurrent explorations on multiple machines, the compiler generates a task assignment file based on the order of explorations and the number of machines to use as specified by the user in the meta data. Let c be the number of configurations to evaluate and p be the number of machines available, the i-th node will evaluate the i+p*j-th smallest (or largest) model, where j [dr)].

To examine the efficacy of the Wootz framework, a set of experiments were conducted. The experiments were designed to answer the following three major questions: 1) Whether pre-training the tuning blocks of a CNN helps the training of that CNN reach a given accuracy sooner? This is referred as the composability hypothesis as its validity is the prerequisite for the composability-based CNN pruning to work. 2) How much benefits can be obtained from composability-based CNN pruning on both the speed and the quality of network pruning while counting the pre-training overhead? 3) How much extra benefits can be obtained from hierarchical tuning block identifier?

The set of experiments used four popular CNN models: ResNet-50 and ResNet-101, as representatives of the Residual Network family, and Inception-V2 and Inception-V3, as representatives of the Inception family. They have 50, 101, 34, 48 layers respectively. These CNN models represent a structural trend in CNN designs, in which, several layers are encapsulated into a generic module of a fixed structure—which is referred as a convolution module—and a network is built by stacking many such modules together. Such CNN models are holding the state-of-the-art accuracy in many challenging deep learning tasks. The structures of these models are described in input Caffe Prototxt files (in which a new construct “module” was added to Prototxt for specifying the boundaries of convolution modules) and then converted to the multiplexing models by the Wootz compiler.

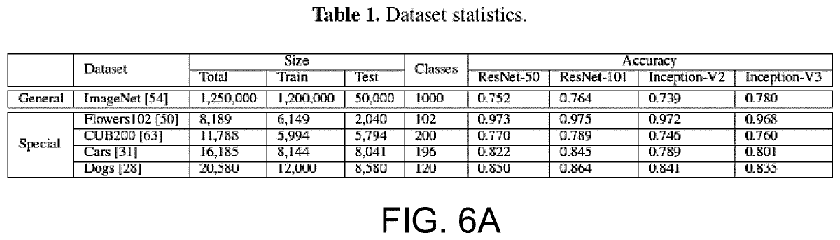

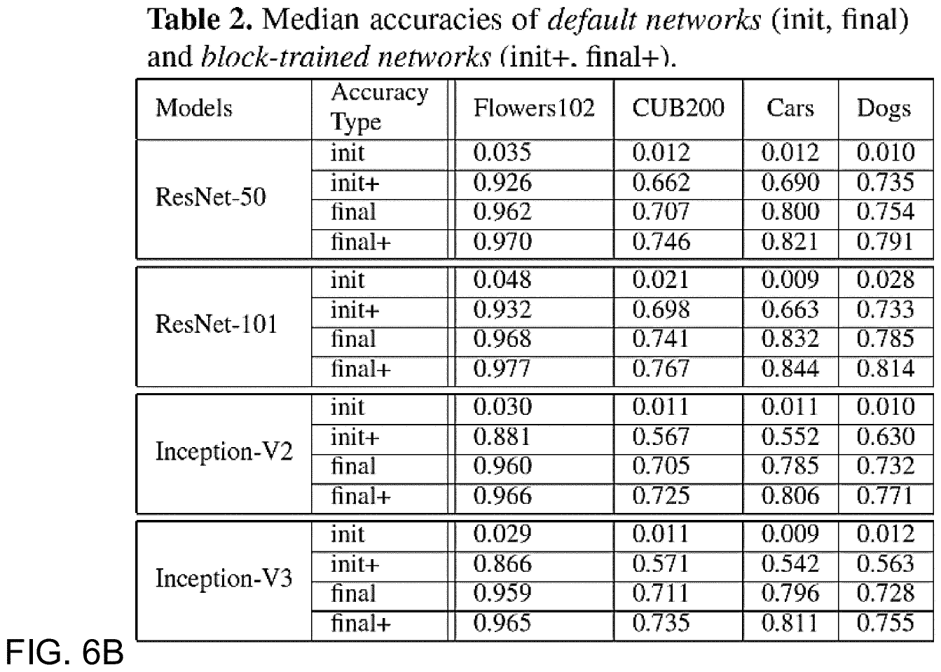

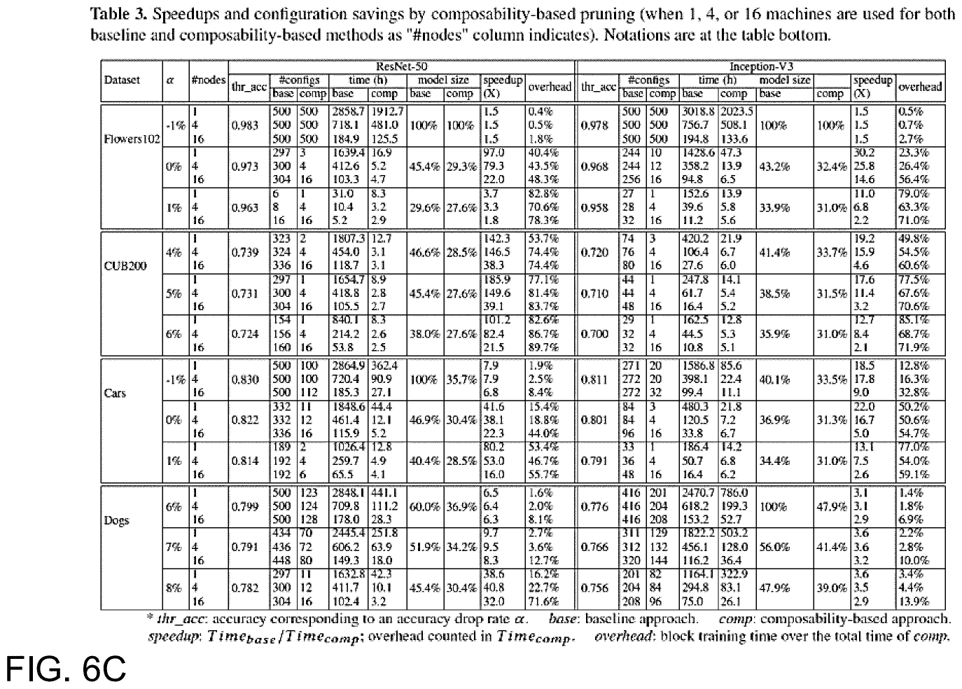

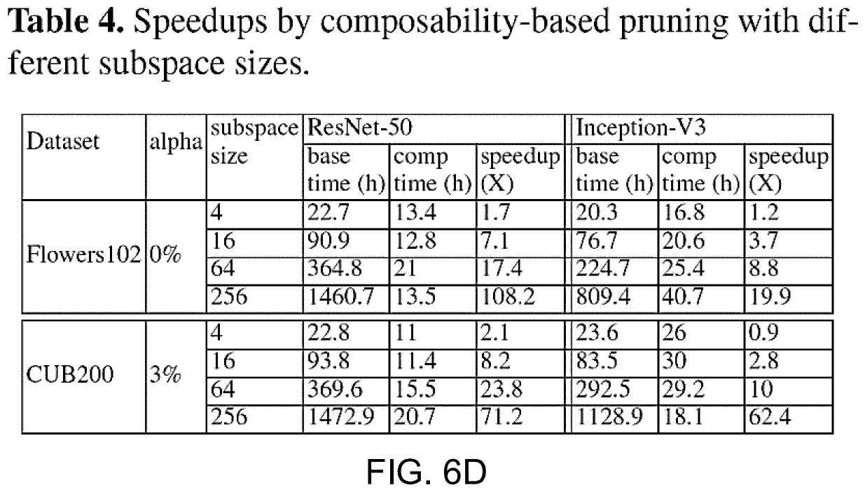

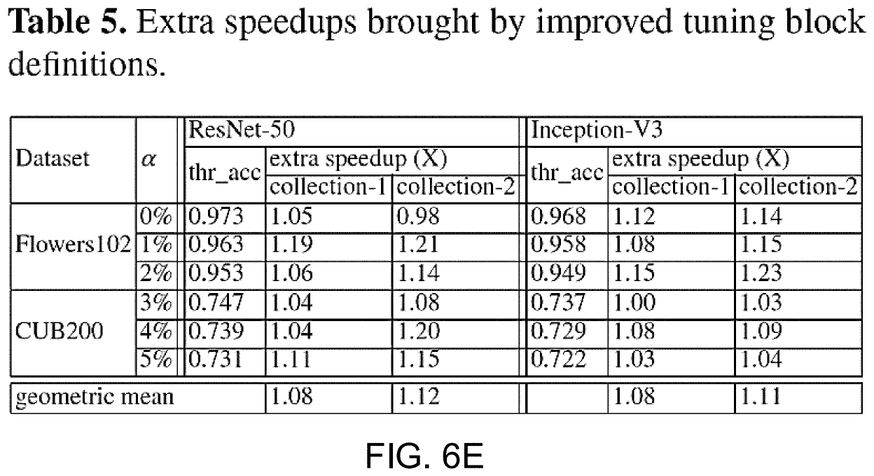

For preparation, the four CNN models already trained on a general image dataset ImageNet (ILSVRC 2012) were adapted to each of four specific image classification tasks with the domain-specific datasets, Flowers102, CUB200, Cars, and Dogs. This resulted in giving us 16 trained full CNN models. The accuracy of the trained ResNets and Inceptions on the test datasets are listed in the Accuracy columns in Table 1 (which is displayed in FIG. 6A).

The four datasets for CNN pruning are commonly used in fine-grained recognition, which is a typical usage scenario of CNN pruning. Table 1 (FIG. 6A) reports the statistics of the four datasets, including the data size for training (Train), the data size for testing (Test), and the number of classes (Classes). For all experiments, network training is performed on the training sets while accuracy results are reported on the testing sets.

In CNN pruning, the full CNN model to prune has typically been already trained on the datasets of interest. When filters in the CNN are pruned, a new model with fewer filters is created, which inherits the remaining parameters of the affected layers and the unaffected layers in the full model. The promising subspace contains such models. The baseline approach trains these models as they are. Although there are prior studies on accelerating CNN pruning, what they propose are all various ways to reduce the configuration space to a promising subspace. To the best of our knowledge, when exploring the configurations in the promising subspace, the prior studies all use the baseline approach. As an exemplary method, in accordance with embodiments of the present disclosure, is the first for speeding up the exploration of the promising space, its results are compared with those from the baseline approach. A pruned network in the baseline approach is referred to as a default network while the one initialized with pre-trained tuning blocks in an exemplary method is referred to as a block-trained network.

The 16 trained CNNs contain up to hundreds of convolutional layers. A typical practice is to use the same pruning rate for the convolutional layers in one convolution module. The same strategy is adopted here. The importance of a filter is determined by its l₁ norm as used in previous work(s). Following prior CNN pruning practice, the top layer of a convolution module is kept unpruned, since it helps ensure the dimension compatibility of the module.

There are many ways to select the promising subspace, i.e., the set of promising configurations worth evaluating. Previous works select configurations either manually or based on reinforcement learning with various rewards or algorithm design. As that is orthogonal to the focus of this work, to avoid bias from that factor, the experiments form the promising spaces through random sampling of the entire pruning space. A promising space contains 500 pruned networks, whose sizes follow a close-to-uniform distribution. In the experiments, the pruning rate for a layer can be one of F={30%, 50%, 70%}.

There are different pruning objectives including minimizing model size, computational cost, memory footprint, or energy consumption. Even though an objective of pruning affects the choice of the best configuration, all objectives require the evaluation of the set of promising configurations. An exemplary composability-based CNN pruning aims at accelerating the training of a set of pruned networks and thus can work with any objective of pruning.

For demonstration purposes, the objective of pruning is set as finding the smallest network (min ModelSize) that meets a given accuracy threshold (Accuracy <=thr_acc). A spectrum of thr_acc values is obtained by varying the accuracy drop rate a from that of the full model from −0.02 to 0.08, and negative drop rates are included because it is possible that pruning makes the model more accurate.

The meta data on the training in both the baseline approach and the composability-based approach are as follows. Pre-training of tuning blocks takes 10,000 steps for all ResNets, with a batch size 32, a fixed learning rate 0.2, and a weight decay 0.0001; pre-training of tuning blocks takes 20,000 steps for all Inceptions, with batch size 32, a fixed learning rate 0.08, and a weight decay 0.0001. The global fine-tuning in the composability-based approach and the network training in the baseline approach uses the same training configurations: max number of steps 30,000, batch size 32, weight decay 0.00001, fixed learning rate 0.001. Other learning rates and dynamic decay schemes were also explored, but no single choice works best for all networks. The rate of 0.001 was selected as it gives the overall best results for the baseline approach.

All the experiments are performed with TensorFlow 1.3.0 on machines each equipped with a 16-core 2.2 GHz AMD Opteron 6274 (Interlagos) processor, 32 GB of RAM and an NVIDIA K20X GPU with 6 GB of DDR5 memory. One network is trained on one GPU.

Empirical validations of the composability hypothesis (i.e., pre-training tuning blocks helps CNN reach an accuracy sooner) is presented here first as its validity is the prerequisite for the composability-based CNN pruning to work. Table 2 (as displayed in FIG. 6B) reports the median of the initial and final accuracies of all 500 block-trained networks and their default counterparts for each of the models on every dataset. The mean is very close (less than 1%) to the median in all the settings. In this experiment, the tuning blocks are simply the CNN modules in each network. Overall, block-trained networks yield better final accuracies than default networks do with one-third less training time.

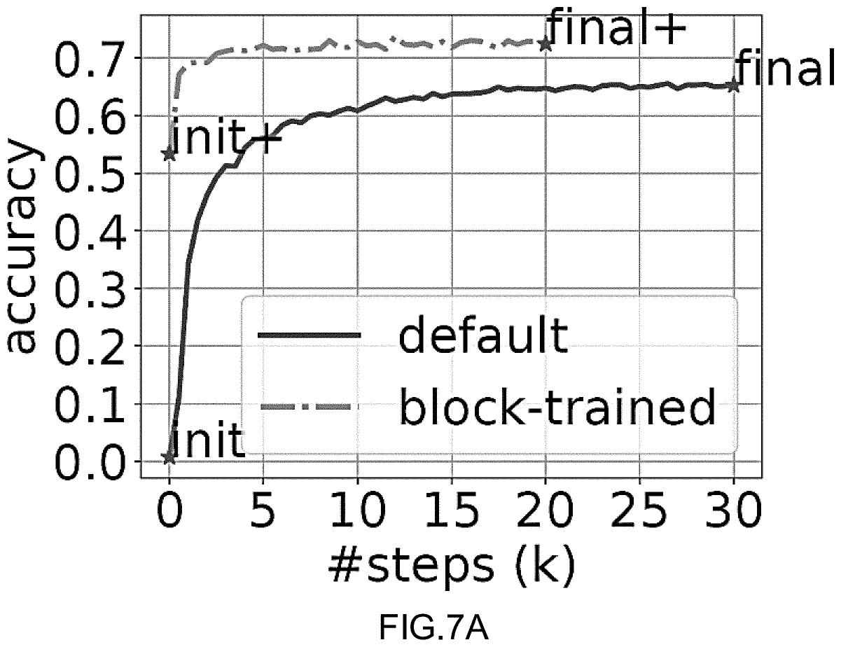

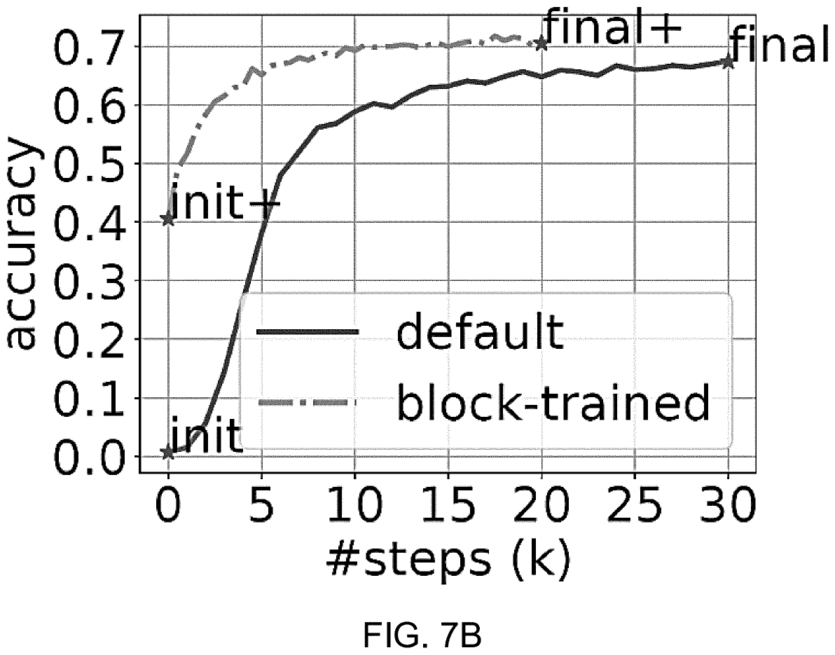

To show the details, the two graphs in FIGS. 7A-7B give accuracy curves attained during the trainings of one of the pruned networks in ResNet-50 and Inception-V3 respectively, in which dataset CUB200 is used. The initial accuracies (init) are close to zero for the default version, while 53.4% and 40.5% for the block-trained version (init+). Moreover, the default version results in only 65.3% and 67.3% final accuracies (final) respectively, while the block-trained version achieves 72.5% and 70.5% after only two-thirds of the training time. Results on other pruned networks show a similar trend.

The results offer strong evidence for the composability hypothesis, showing that pre-training the tuning blocks of a CNN can indeed help the training of that CNN reach a given accuracy sooner. The benefits do not come for free; overhead is incurred by the pre-training of the tuning blocks.

To assess an exemplary Wootz compiler-based framework, the performance of composability-based network pruning is first evaluated and then the extra benefits from the hierarchical tuning blocks identifier are reported. To measure the basic benefits from the composability-based method, experiments are conducted using every convolution module in these networks as a tuning block. The extra benefits from hierarchical tuning block identification are reported later.

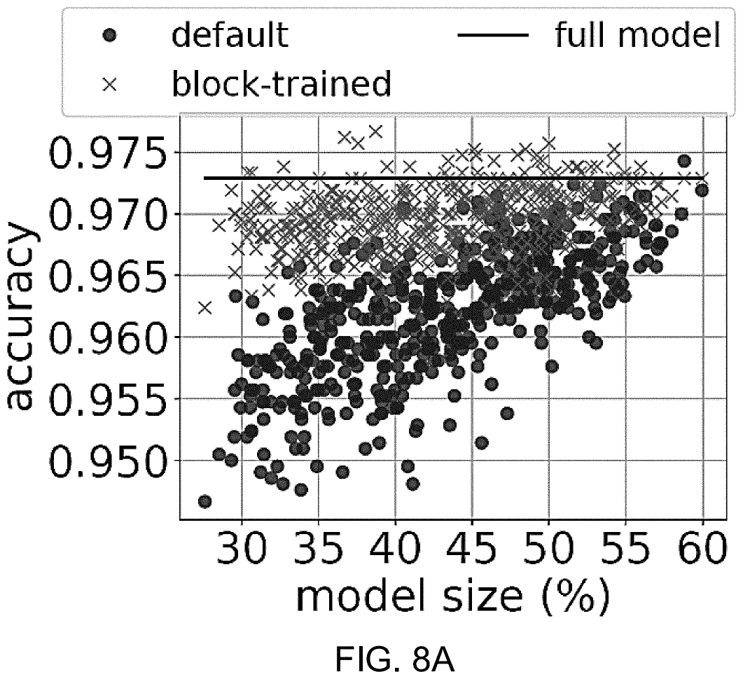

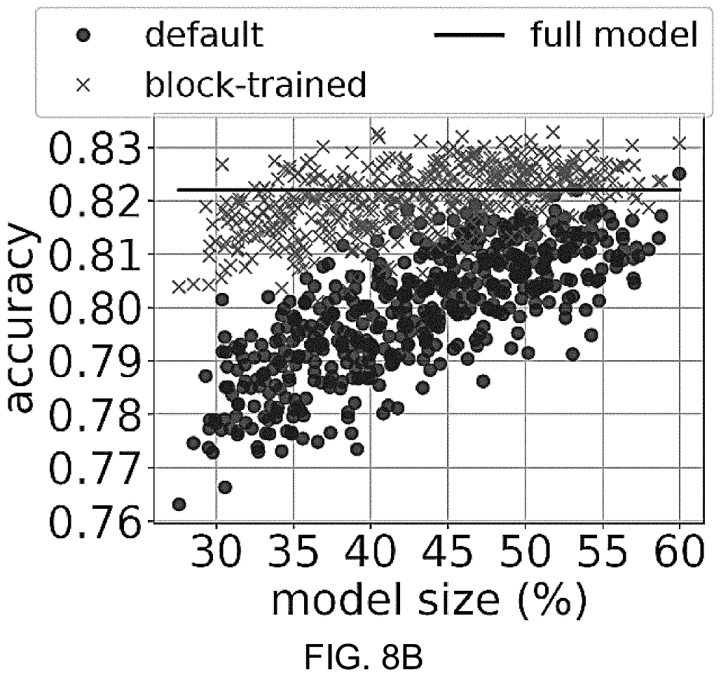

FIGS. 8A-8B show the final accuracies of all the 500 ResNet-50 variants trained with or without leveraging composability on the Flower102 and CUB200 datasets. For reference, the accuracies of the well-trained full ResNet-50 on the two datasets are also plotted. As demonstrated by the figures, the block-trained network gives a clearly better final accuracy overall, which echoes the results reported in the previous subsection.

Table 3 (as displayed in FIG. 6C) reports the comparisons between the block-trained version and the default version, in both speeds and network sizes, at various levels of tolerable accuracy drop rates a (negative means higher accuracy than the large network gives). The results are collected when 1, 4, or 16 machines are used for concurrent training for both the baseline and an exemplary training method (indicated by the “#nodes” column). The time of the block-trained version already takes the pre-training time of tuning blocks into account (“overhead” in Table 3 (FIG. 6C) shows the percentage in overall time). For the objective of pruning, the exploration order Wootz adopts is to start from the smallest models and proceed to larger ones.

The results show that the composability-based method avoids up to 99.6% of trial configurations and reduces the evaluation time by up to 186× for pruning ResNet-50 and up to 96.7% reduction & 30× speedups for Inception-V3. The reduction of trial configurations is because the method improves the accuracy of the pruned networks as FIGS. 8A-8B show. As a result, the exploration meets a desirable configuration sooner. For instance, in Flower102 (α=0), the third smallest network can already reach the target accuracy in the block-trained version, while the 297th network meets the target in the default version. This not only shortens the exploration time, but also yields more compact (up to 70% smaller) networks as the “model size” columns in Table 3 (FIG. 6C) show. Another reason for the speedup is that the training of a block-trained network takes fewer iterations to reach its final accuracy level than the default version, as FIGS. 7A-7B have illustrated. So even when configurations are not reduced (e.g., Flower102, α=−1), the block-trained exploration finishes sooner.

Table 4 (as displayed in FIG. 6D) shows the speedups by composability-based pruning with different subspace sizes. The speedups are higher as the number of configurations to explore increases. It is because the time for pre-training tuning blocks weights decreases as the total time increases and the reduction of configurations becomes more significant for a larger set. Another observation is that, when the number of configurations is only four, there is still a significant speedup in most of cases. The block training time is the time spent on pre-training all the tuning block variants (48 for ResNet-50 and 27 for Inception-V3). The speedup could be higher if tuning block identifier is applied, as shown next.

Hierarchical tuning block identifier balances the overhead of training tuning blocks and the time savings they bring to the finetuning of pruned networks. Table 5 (as displayed in FIG. 6E) reports the extra speedups brought when it is used. For datasets Flowers102 and CUB200, two types of collections of configurations with N=8 were experimented with. The first type, “collection-1”, was a randomly sampled collection as mentioned earlier, and the second type, “collection-2”, was attained by setting one pruning rate for a sequence of convolution modules, similar to some previous work(s) to reduce module-wise meta-parameters. For each type, the experiments were repeated five times with a new collection created each time.

Each tuning block identified from the first collection tends to contain only one convolution module due to the independence in choosing the pruning rate for each module. But the average number of tuning blocks is less than the total number of possible pruned convolution modules (41 versus 48 for ResNet-50 and 27 versus 33 for Inception-V3) because of the small collection size. The latter one (collection-2) has tuning blocks that contain a sequence of convolution modules as they are set to use one pruning rate.

The extra speedups from the exemplary training algorithm are substantial for both types, but more so for the latter one (collection-2) for the opportunities that some larger popular tuning blocks have for benefiting the networks in that collection. Because some tuning blocks selected by the algorithm are a sequence of convolution modules that frequently appear in the collections, the total number of tuning blocks becomes smaller (e.g., 27 versus 23 on Inception-V3.)

Recent years have seen many studies on speeding up the training and inference of CNN, both in software and hardware. For the large volume, it is hard to list them all; some examples involve software optimizations and work on special hardware designs. These studies are orthogonal to the teachings of the present disclosure. Although they can potentially apply to the training of pruned CNNs, they are not specifically designed for CNN pruning. They focus on speeding up the computations within one CNN network. In contrast, the present disclosure exploits cross-network computation reuse and the special properties of CNN pruning: (a) many configurations to explore, (b) common layers shared among them, and most importantly, (c) the composability unveiled in the present disclosure.

Deep neural networks are known to have many redundant parameters and thus could be pruned to more compact architectures. Network pruning can work at different granularity levels such as weights/connections, kernels, and filters/channels. Filter-level pruning is a naturally structured way of pruning without introducing sparsity by avoiding creating the need for sparse libraries or specialized hardware. Given a well-trained network, different metrics to evaluate filters importance are proposed such as Taylor expansion, l1 norm of neuron weights, Average Percentage of Zeros, feature maps' reconstruction errors, and scaling factors of batch normalization layers. These techniques, along with general algorithm configuration techniques and recent reinforcement learning-based methods, show promise in reducing the configuration space worth exploring. The present disclosure distinctively aims at reducing the evaluation time of the remaining configurations by eliminating redundant training.

Another line of work in network pruning conducts pruning dynamically at runtime. Their goals are however different from that of the present disclosure. Instead of finding the best small network, they try to generate networks that can adaptively activate only part of the network for inference on a given input. Because each part of the generated network may be needed for some inputs, the overall size of the generated network could be still large. They are not designed to minimize the network to meet the limited resource constraints on a system.

While Sequitur has been applied to various tasks, including program and data pattern analysis, it has not been seen in use in CNN pruning. And, although several studies have attempted to train a student network to mimic the output of a teacher network, an exemplary training method in accordance with the present disclosure works at a different level. Rather than training an entire network, pieces of a network are trained in accordance with various embodiments of the present disclosure. We are not aware of the prior use of such a scheme at this level.

The present disclosure presents a novel composability-based approach to accelerating CNN pruning via computation reuse. In accordance with the present disclosure, a hierarchical compression-based algorithm is designed to efficiently identify tuning blocks for pre-training and effective reuse and a Wootz compiler-based software framework is developed that automates the application of the composability-based approach to an arbitrary CNN model. Experiments show that network pruning enabled by the Wootz compiler shortens the state-of-the-art pruning process by up to 186× while producing significantly better pruned networks. As CNN pruning is an important method to adapt a large CNN model to a more specialized task or to fit a device with power or space constraints, its required long exploration time has been a major barrier for timely delivery of many AI products. The promising results of an exemplary Wootz compiler-based framework indicate its potential for significantly lowering the barrier, and hence reducing the time to market AI products.

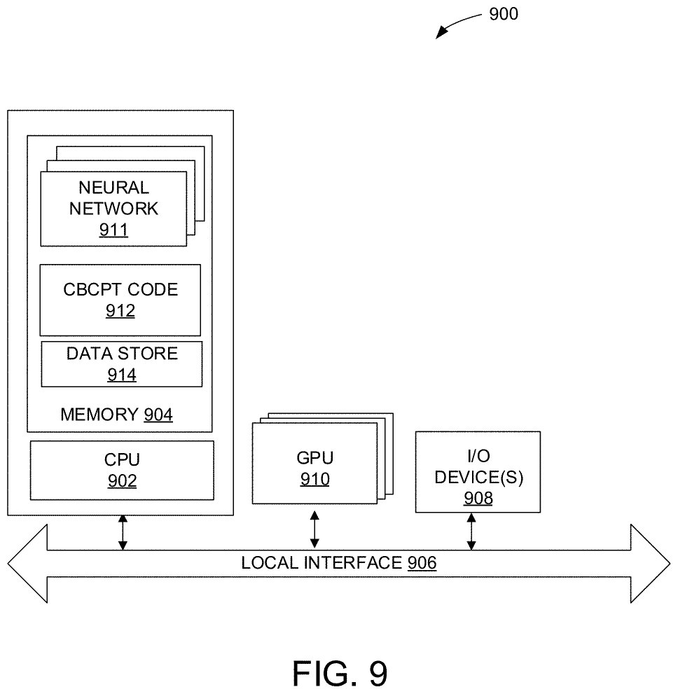

FIG. 9 depicts a schematic block diagram of a computing device 900 that can be used to implement various embodiments of the present disclosure. An exemplary computing device 900 includes at least one processor circuit, for example, having a processor 902 and a memory 904, both of which are coupled to a local interface 906, and one or more input and output (I/O) devices 908. The local interface 906 may comprise, for example, a data bus with an accompanying address/control bus or other bus structure as can be appreciated. The computing device 900 further includes Graphical Processing Unit(s) (GPU) 910 that are coupled to the local interface 906 and may utilize memory 904 and/or may have its own dedicated memory. The CPU and/or GPU(s) can perform various operations such as image enhancement, graphics rendering, image/video processing, recognition (e.g., text recognition, object recognition, feature recognition, etc.), image stabilization, machine learning, filtering, image classification, and any of the various operations described herein.

Stored in the memory 904 are both data and several components that are executable by the processor 902. In particular, stored in the memory 904 and executable by the processor 902 are code for implementing one or more neural network (e.g., convolutional neural network (CNN)) models 911 and logic/instructions/code 912 for composability-based CNN pruning and training (CBCPT) the neural network model(s) 911. Also stored in the memory 904 may be a data store 914 and other data. The data store 914 can include an image database for source images, target images, and potentially other data. In addition, an operating system may be stored in the memory 904 and executable by the processor 902. The I/O devices 908 may include input devices, for example but not limited to, a keyboard, mouse, etc. Furthermore, the I/O devices 908 may also include output devices, for example but not limited to, a printer, display, etc.

Certain embodiments of the present disclosure can be implemented in hardware, software, firmware, or a combination thereof. If implemented in software, the composability-based CNN pruning and training (CBCPT) logic or functionality are implemented in software or firmware that is stored in a memory and that is executed by a suitable instruction execution system. If implemented in hardware, the composability-based CNN pruning and training (CBCPT) logic or functionality can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A method of training a pruned neural network comprising:
defining, by at least one computing device, a plurality of tuning blocks within a neural network, wherein a tuning block is a sequence of consecutive convolutional neural network layers of the neural network, wherein the tuning block does not have an overlapping convolutional neural network layer with another one of the plurality of tuning blocks;
pruning, by the at least one computing device, at least one of the plurality of tuning blocks to form at least one pruned tuning block, wherein at least one filter is removed from a convolutional neural network layer of the at least one of the plurality of tuning blocks;
pre-training, by the at least one computing device, the at least one pruned tuning block to form at least one pre-trained tuning block;
assembling, by the at least one computing device, the at least one pre-trained tuning block with other ones of the plurality of tuning blocks of the neural network to form a pruned neural network; and
training, by the at least one computing device, the pruned neural network, wherein the at least one pre-trained tuning block is initialized with weights resulting from the pre-training of the at least one pruned tuning block.

2. The method of claim 1, wherein the other ones of the tuning blocks comprise at least one tuning block that is not pre-trained.

3. The method of claim 1, wherein the other ones of the tuning blocks comprise at least one tuning block that is not pruned.

4. The method of claim 1, further comprising assembling a second pruned neural network from a subset of the plurality of tuning blocks of the neural network, wherein the subset includes the at least one pre-trained tuning block of the pruned neural network.

5. The method of claim 1, wherein the at least one of the plurality of tuning blocks comprises multiple tuning blocks, the method further comprising portioning all of the of tuning blocks into groups, wherein a group of tuning blocks is pre-trained at a time.

6. The method of claim 1, wherein all parameters in the pruned neural network are updated during the training of the pruned neural network, wherein a subset of the parameters are initialized during the pre-training of the at least one pruned tuning block.

7. The method of claim 1, wherein an activation map produced by a tuning block in the neural network is reused in pre-training a pruned version of the tuning block.

8. The method of claim 1, wherein the at least one pruned tuning block comprises multiple pruned tuning blocks, wherein the multiple pruned tuning blocks are concurrently pre-trained.

9. The method of claim 1, further comprising selecting a tuning block for pre-training based on a frequency that the tuning block appears in the neural network.

10. The method of claim 1, further comprising selecting a tuning block for pre-training based on a size of the tuning block.

11. The method of claim 1, wherein the neural network pre-trains the at least one pruned tuning block in a teacher-student training arrangement.

12. The method of claim 1, wherein the neural network trains the pruned neural network in a teacher-student training arrangement.

13. A system of training a pruned neural network comprising:
at least one processor; and
memory configured to communicate with the at least one processor, wherein the memory stores instructions that, in response to execution by the at least one processor, cause the at least one processor to perform operations comprising:
defining a plurality of tuning blocks within a neural network, wherein a tuning block is a sequence of consecutive convolutional neural network layers of the neural network, wherein the tuning block does not have an overlapping convolutional neural network layer with another one of the plurality of tuning blocks;
pruning at least one of the plurality of tuning blocks to form at least one pruned tuning block, wherein at least one filter is removed from a convolutional neural network layer of the at least one of the plurality of tuning blocks;
pre-training the at least one pruned tuning block to form at least one pre-trained tuning block;
assembling the at least one pre-trained tuning block with other ones of the plurality of tuning blocks of the neural network to form a pruned neural network; and
training the pruned neural network, wherein the at least one pre-trained tuning block is initialized with weights resulting from the pre-training of the at least one pruned tuning block.

14. The system of claim 13, wherein the other ones of the tuning blocks comprise at least one tuning block that is not pre-trained.

15. The system of claim 13, wherein the other ones of the tuning blocks comprise at least one tuning block that is not pruned.

16. The system of claim 13, wherein the operations further comprise assembling a second pruned neural network from a subset of the plurality of tuning blocks of the neural network, wherein the subset includes the at least one pre-trained tuning block of the pruned neural network.

17. The system of claim 13, wherein the at least one of the plurality of tuning blocks comprises multiple tuning blocks, wherein the operations further comprise portioning all of the of tuning blocks into groups, wherein a group of tuning blocks is pre-trained at a time.

18. The system of claim 13, wherein all parameters in the pruned neural network are updated during the training of the pruned neural network, wherein a subset of the parameters are initialized during the pre-training of the at least one pruned tuning block.

19. The system of claim 13, wherein the operations further comprise selecting a tuning block for pre-training based on a frequency that the tuning block appears in the neural network and a size of the tuning block.

20. The system of claim 13, wherein the neural network pre-trains the at least one pruned tuning block and the pruned neural network in a teacher-student training arrangement, wherein the at least one processor implements training by the neural network.
